(19) United States
(12) Patent Application Publication
(10) Pub. No.: US 2011/0200865 A1
(43) Pub. Date: Aug. 18, 2011

(54) SECONDARY BATTERY AND BATTERY MODULE INCLUDING THE SAME

(76) Inventors: Sang-Won Byun, Yongin-si (KR); Sung-Bae Kim, Yongin-si (KR); Yong-Sam Kim, Yongin-si (KR)

(21) Appl. No.: 12/834,868

(22) Filed: Jul. 12, 2010

Related U.S. Application Data
(60) Provisional application No. 61/305,922, filed on Feb. 18, 2010.

(51) Int. Cl. H01M 6/42; H01M 2/02

(52) U.S. Cl. 429/156; 429/163

(57) ABSTRACT

A secondary battery includes an electrode assembly having a first electrode plate, a second electrode plate, and a separator located between the first and second electrode plates, wherein the first electrode plate and the second electrode plate each have a coated portion and a non-coated portion; a case housing the electrode assembly; a first current collector and a second current collector electrically coupled to the electrode assembly; and a retainer coupled to the electrode assembly and to the first current collector to fix the first current collector to the electrode assembly.

### CROSS-REFERENCE TO RELATED APPLICATIONS

This application claims the benefit of U.S. Provisional Application No. 61/305,922, filed on Feb. 18, 2010, in the United States Patent and Trademark Office, the entire disclosure of which is incorporated herein by reference.

### BACKGROUND

1. Field

One or more embodiments of the present invention relate to a secondary battery and a battery module including a plurality of secondary batteries that are connected to one another.

2. Description of Related Art

Secondary batteries, which are rechargable batteries, are used as energy sources of mobile devices, electric cars, hybrid cars, electric bicycles, and uninterruptible power supplies. The secondary battery can be used, according to the type of an external device powered by the secondary battery, as a single battery type or as a battery module type in which a plurality of single batteries are electrically coupled to one another in one bundle.

### SUMMARY

One or more embodiments of the present invention include a secondary battery and a battery module that can prevent or reduce the likelihood of an electrode assembly functioning as a power generation device from being damaged and can stabilize electrical connection of the electrode assembly.

One or more embodiments of the present invention include a secondary battery and a battery module that can prevent an electrode assembly from moving and thus improve durability and reliability of the electrode assembly.

According to one or more embodiments of the present invention, a secondary battery includes an electrode assembly having a first electrode plate, a second electrode plate, and a separator located between the first and second electrode plates, wherein the first electrode plate and the second electrode plate each have a coated portion and a non-coated portion; a case housing the electrode assembly; a first current collector and a second current collector electrically coupled to the electrode assembly; and a retainer coupled to the electrode assembly and to the first current collector to fix the first current collector to the electrode assembly.

In one embodiment, the retainer is a clip and may include a backing and two ribs extending from the backing to define an accommodation portion configured to receive a portion of the electrode assembly. In one embodiment, the two ribs have different thicknesses and retainer is made from an electrically insulating material and/or an elastic material.

According to one or more embodiments of the present invention, a retainer for fixing an electrode assembly is formed, and thus structural rigidity capable of withstanding external vibration or impact can be obtained, thereby improving durability and reliability of a product.

The electrode assembly may move inside a case due to external vibration or impact or may be damaged due to collision between the electrode assembly and the case, or electrical connection of the electrode assembly may be cut off. According to an embodiment of the present invention, the electrode assembly is fixed to an electrode current collecting member, and thus the electrode assembly can be prevented from moving and being damaged, thereby stabilizing electrical connection of the electrode assembly.

### BRIEF DESCRIPTION OF THE DRAWINGS

FIG. 1 is a perspective view illustrating a battery module according to an embodiment of the present invention;

FIG. 2 is a vertical cross-sectional view of a secondary battery taken along a line II-II of FIG. 1;

FIG. 3 is a from view of a partially unraveled electrode assembly of FIG. 2;

FIG. 4 is a cross-sectional view taken along a line IV-IV of FIG. 2;

FIG. 5 is an exploded perspective view of a portion of the secondary battery according to an embodiment of the present invention;

FIG. 6 is a view illustrating a retainer according to an embodiment of the present invention;

FIG. 7 is a partially exploded perspective view of a portion of the secondary battery according to an embodiment of the present invention;

FIG. 8 is a perspective view illustrating an assembly state of a retainer according to another embodiment of the present invention; and

FIG. 9 is a cross-sectional view taken along a line IX-IX of FIG. 8.

FIG. 10 is a perspective view of a retainer according to another embodiment of the present invention.

### EXPLANATION OF REFERENCE NUMERALS DESIGNATING THE MAJOR ELEMENTS OF THE DRAWINGS

10: electrode assembly
11: positive electrode plate
11a: positive electrode current collecting plate
11b: positive electrode active material layer
11c: positive electrode non-coated portion
12: negative electrode plate
12a: negative electrode current collecting plate
12b: negative electrode active material layer
12c: negative electrode non-coated portion
13: separator
20: secondary battery
21: positive electrode terminal
22: negative electrode terminal
24: washer
29, 33: bolt
25: upper gasket
26: insulating sealing material
27: lower gasket
30: cap assembly
31: cap plate
31′: terminal hole
32: bus bar
34: case
38: sealing cap
38a: electrolyte injection port
39: safety bent
50: positive electrode current collecting member
51: positive electrode connecting member
52: positive electrode current collecting terminal
60: negative electrode current collecting member
61: negative electrode connecting member
62: negative electrode current collecting terminal
80, 180, 280: retainer
80′, 180′: accommodation portion of retainer
180″: gas discharging hole
100: battery module
w: width of accommodation portion of retainer
t: length of accommodation portion of retainer

### DETAILED DESCRIPTION

Reference will now be made in detail to embodiments, examples of which are illustrated in the accompanying drawings, wherein like reference numerals refer to the like elements throughout.

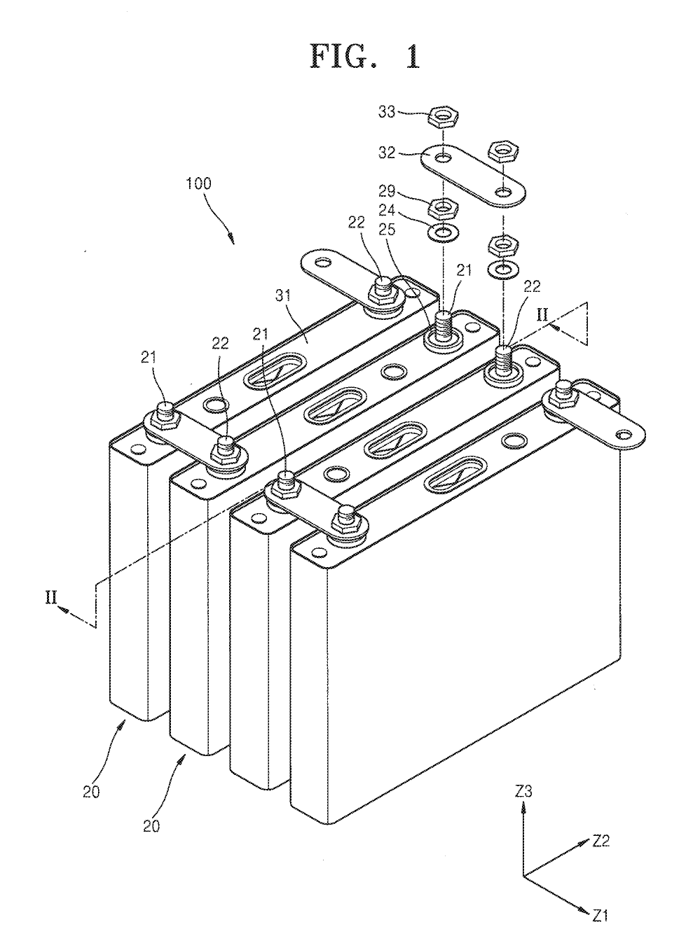

FIG. 1 is a perspective view illustrating a battery module according to an embodiment of the present invention.

Referring to FIG. 1, the battery module 100 includes a plurality of secondary batteries 20 that are arranged in rows. For example, the battery module 100 may include the secondary batteries 20 that are arranged in a first direction Z1 and may have a stacked structure including the secondary batteries 20 arranged in a row or in more than two rows.

One pair of positive and negative electrode terminals 21 and 22 may be formed in each secondary battery 20 to protrude to the outside. A washer 24 and a nut 29 are coupled with each of the positive and negative electrode terminals 21 and 22 via an insulating gasket 25. The secondary batteries 20 are electrically coupled to one another by connecting the positive and negative electrode terminals 21 and 22 to each other. In this case, the same polarities of the secondary batteries 20 may be connected to one another in parallel or opposite polarities thereof may be connected to one another in series. For example, the positive and negative electrode terminals 21 and 22 may be connected to each other via a bus bar 32. The secondary battery 20 may be connected to the adjacent secondary battery 20 via the bus bar 32. For example, both the positive and negative electrode terminals 21 and 22 have a bolt shape, and the positive and negative electrode terminals 21 and 22 of the adjacent secondary batteries 20 penetrate the bus bar 32 and are coupled to a nut 33, thereby electrically connecting the one pair of secondary batteries 20 to each other.

For example, the secondary batteries 20 may be alternately arranged so that the adjacent secondary batteries 20 having opposite polarities are adjacent to each other. In this case, the positive electrode terminal 21 of the secondary battery 20 may be connected to the negative electrode terminal 22 of the adjacent secondary battery 20 via the bus bar 32, and the negative electrode terminal 22 of the secondary battery 20 may be connected to another positive electrode terminal 21 of the adjacent another secondary battery 20 via bus bar 32.

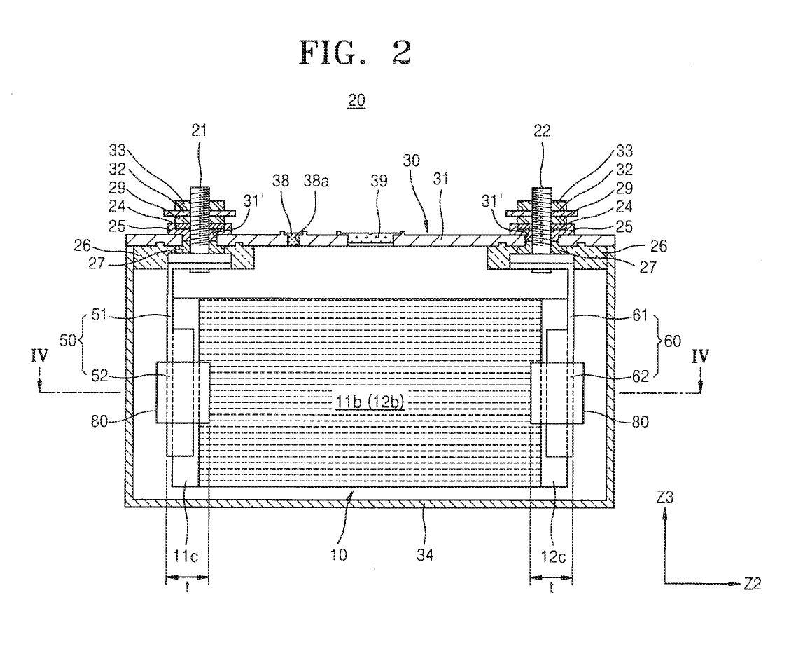

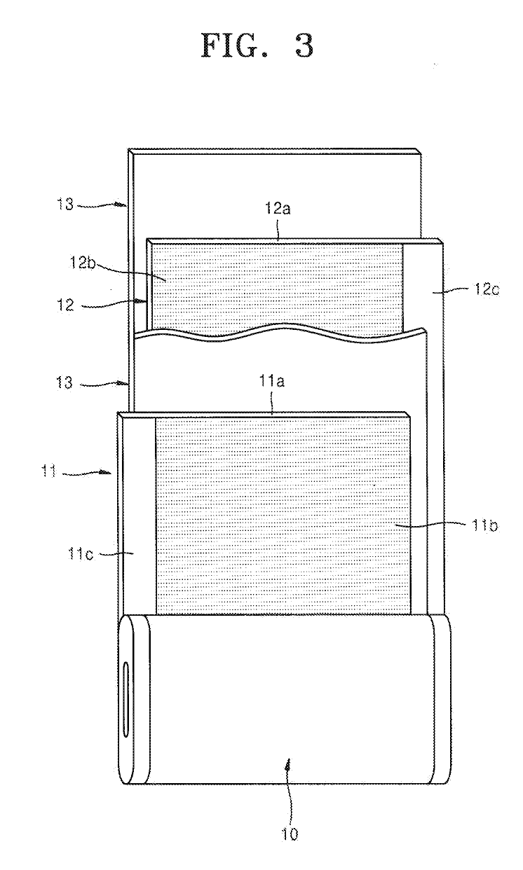

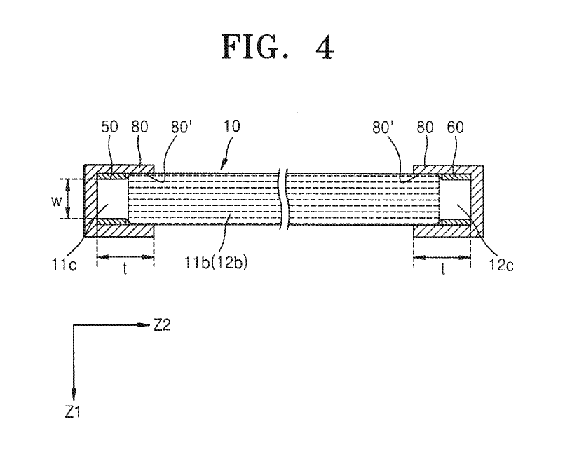

FIG. 2 is a vertical cross-sectional view of the secondary battery 20 taken along a line II-II of FIG. 1. FIG. 3 is a view for describing an electrode assembly 10 of FIG. 2. FIG. 4 is a cross-sectional view taken along a line IV-IV of FIG. 2.

Referring to FIGS. 2 through 4, the secondary battery 20 includes the electrode assembly 10, a case 34 accommodating the electrode assembly 10, and a cap assembly 30 closing an upper portion of the case 34. Referring to FIG. 3, the electrode assembly 10 includes a positive electrode plate 11, a negative electrode plate 12, and a separator 13 between the positive electrode plate 11 and the negative electrode plate 12. A stacked body including the positive electrode plate 11, the negative electrode plate 12 and the separator 13 may be wound in a jelly-roll shape. The positive electrode plate 11 includes a positive electrode current collector 11a, a positive electrode active material layer 11b that is formed on at least one surface of the positive electrode current collector 11a, and a positive electrode non-coated portion 11c that is formed on an end portion of the positive electrode plate 11 in a width direction of the positive electrode current collector 11a, wherein the positive electrode non-coated portion 11c is a region where the positive electrode active material layer 11b is not formed.

The negative electrode plate 12 includes a negative electrode current collector 12a, a negative electrode active material layer 12b that is formed on at least one surface of the negative electrode current collector 12a, and a negative electrode non-coated portion 12c that is formed on an end portion of the positive electrode plate 12 in a width direction of the positive electrode current collector 12a, wherein the positive electrode non-coated portion 12c is a region where the positive electrode active material layer 12b is not formed.

In this case, the positive electrode non-coated portion 11c and the negative electrode non-coated portion 12c are respectively located on opposite ends of the electrode assembly 10 in a width direction of the electrode assembly 10. As illustrated in FIG. 2, the positive electrode non-coated portion 11c and the negative electrode non-coated portion 12c of the electrode assembly 10 are configured to be inserted into both sides of the case 34. A positive electrode current collecting member 50 is electrically coupled to the positive electrode non-coated portion 11c, and a negative electrode current collecting member 60 is electrically coupled to the negative electrode non-coated portion 12c. Connection between the positive electrode non-coated portion 11c and the positive electrode current collecting member 50, and connection between the negative electrode non-coated portion 12c and the negative electrode current collecting member 60 may be performed by laser welding or ultrasonic welding.

For example, positive and negative electrode current collecting terminals 52 and 62 of the positive and negative electrode current collecting members 50 and 60 are respectively oriented to be overlapped on the positive and negative electrode non-coated portions 11c and 12c, and then welding is performed on the positive and negative electrode current collecting terminals 52 and 62 to form connecting portions.

Meanwhile, a retainer 80 is coupled to both ends of the electrode assembly 10. As an embodiment of the present invention, the retainer 80 may be formed as a clip type member having an accommodation portion 80′ (see FIG. 4) to be coupled to the electrode assembly 10 and may be formed of a material having electrically insulating properties.

The electrode assembly 10 and the positive and negative electrode current collecting members 50 and 60 are inserted into the retainer 80 to form one body. In this case, a width of the accommodation portion 80′ of the retainer 80 may be set to be narrow so that the electrode assembly 10 and the positive and negative electrode current collecting members 50 and 60 are coupled by forced insertion. Thus, the electrode assembly 10 and each of the positive and negative electrode current collecting members 50 and 60 may be firmly coupled to each other.

The electrode assembly 10 may move inside the case 34 due to external vibration or impact, or may be damaged due to collision between the electrode assembly 10 and the case 34. Furthermore, electrical connection between the electrode assembly 10 and each of the positive and negative electrode current collecting members 50 and 60 may be cut off due to movement of the electrode assembly 10. The retainer 80 may surround an end of the electrode assembly 10 to firmly fix the electrode assembly 10 to each of the positive and negative electrode current collecting members 50 and 60, and thus the electrode assembly 10 may be prevented from significantly moving inside the case 34 or from being damaged, thereby stabilizing electrical connection of the electrode assembly 10. Thus, the retainer 80 may provide structural rigidity capable of withstanding external vibration or impact, thereby improving durability and reliability of a product.

As another embodiment of the present invention, the retainer 80 may be formed of an elastic material, accommodate the electrode assembly 10 and the positive and negative electrode current collecting members 50 and 60 in an elastically transformed state, and providing a bias force to the electrode assembly 10 and the positive and negative electrode current collecting members 50 and 60 that are inserted into the retainer 80.

The electrode assembly 10 and each of the positive and negative electrode current collecting members 50 and 60 may be inserted together into the retainer 80, so that the retainer 80 is not easily separated from the positive and negative electrode current collecting members 50 and 60 by fixing the electrode assembly 10 to the positive and negative electrode current collecting members 50 and 60. As an embodiment of the present invention, the retainer 80 may be coupled to any one of the positive electrode non-coated portion 11c and the negative electrode non-coated portion 12c of the electrode assembly 10, or may be coupled to both the positive electrode non-coated portion 11c and the negative electrode non-coated portion 12c of the electrode assembly 10, as illustrated in FIG. 2.

As an embodiment of the present invention, the accommodation portion 80′ accommodating the electrode assembly 10 may sufficiently extend by a length t, so that the active material layers 11b and 12b together with the positive and negative non-coated portions 11c and 12c are inserted into the retainer 80 in a width direction Z2 (a second direction). The retainer 80 covers even the active material layers 11b and 12b, and thus a contact surface between the retainer 80 and the electrode assembly 10 is enlarged and coupling therebetween is increased, thereby firmly fixing the electrode assembly 10 to the retainer 80.

The positive and negative non-coated portions 11c and 12c of the electrode assembly 10, which respectively correspond to the positive electrode current collector 11a and the negative electrode current collector 12a, are sheet substrates on which an active material is not coated, and thus the positive and negative non-coated portions 11c and 12c have lower rigidities compared to the active material layers 11b and 12b. In an embodiment in which the retainer 80 covers only the positive and negative non-coated portions 11c and 12c of the electrode assembly 10, the electrode assembly 10 may move due to crumpling or bending of the positive and negative non-coated portions 11c and 12c. The retainer 80 is designed to cover the active material layers 11b and 12b that have relatively high rigidity, and thus the electrode assembly 10 may be firmly fixed.

Meanwhile, the cap assembly 30 includes a cap plate 31 closing an upper portion of the case 34. The cap plate 31 and the case 34 may be tightly coupled by laser welding. The cap plate 31 includes a safety vent 39 that is configured to fracture to provide a discharge gas path when an inner pressure of the case 34 exceeds a threshold pressure. Furthermore, the cap plate 31 includes an electrolyte injection port 38a for injecting an electrolyte into the case 34. After the injection of the electrolyte is finished, the electrolyte injection port 38a is closed by a sealing cap 38.

The positive electrode current collecting member 50 is electrically coupled to the positive electrode terminal 21. The positive electrode terminal 21 penetrates the cap plate 31 and is exposed from the cap plate 31 by a certain length. The negative electrode current collecting member 60 is electrically coupled to the negative electrode terminal 22. The negative electrode terminal 22 penetrates the cap plate 31 and is exposed from the cap plate 31 by a certain length. The cap plate 31 includes a terminal hole 31′ through which the positive and negative electrode terminals 21 and 22 penetrate.

The positive and negative electrode terminals 21 and 22 are coupled in an insulated state from the cap plate 31. Insulating gaskets 25 and 27 are formed between each of the positive and negative electrode terminals 21 and 22 and the cap plate 31 to insulate them from each other. For example, the insulating gaskets 25 and 27 include a lower gasket 27 and an upper gasket 25. The lower gasket 27 is inserted into the terminal hole 31′ from a lower portion of the cap plate 31, and the upper gasket 25 is inserted into the terminal hole 31′ from an upper portion of the cap plate 31. Additionally, an insulating sealing material 26 may be included to insulate each of the positive and negative electrode terminals 21 and 22 from the cap plate 31 or to insulate each of the positive and negative electrode terminals 21 and 22 from the case 34.

In one embodiment, both the positive and negative electrode terminals 21 and 22 protruding from the upper portion of the cap plate 31 have a bolt shape having a screw thread. The washer 24 and the nut 29 are coupled to the positive and negative electrode terminals 21 and 22. The positive and negative electrode terminals 21 and 22 penetrate the bus bar 32 and are coupled to the nut 29, thereby connecting adjacent secondary batteries 20. The nut 33 is coupled to the bus bar 32 to fix the bus bar 32 to the positive and negative electrode terminals 21 and 22.

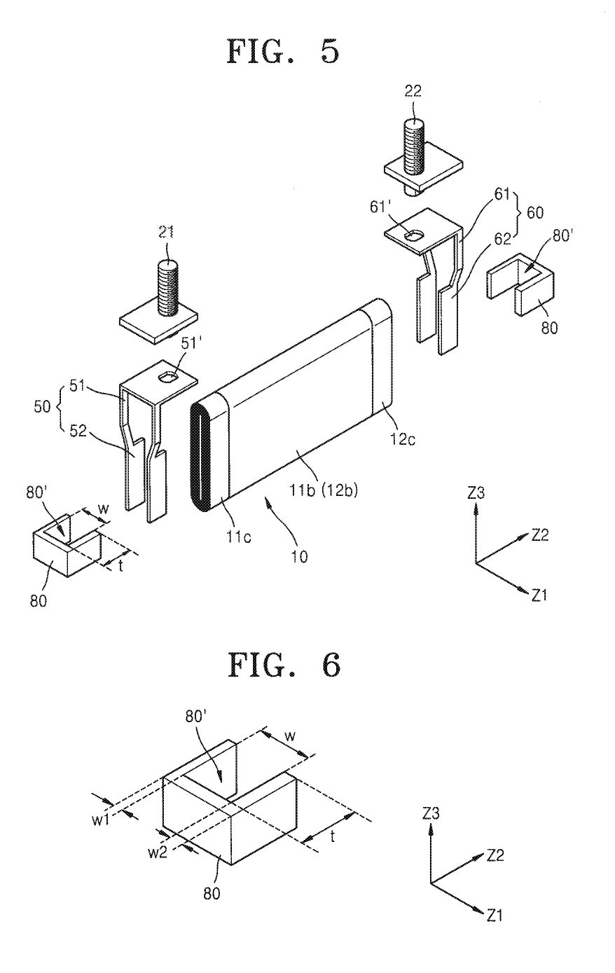

FIG. 5 is a perspective view illustrating an assembly state of the retainer 80 according to an embodiment of the present invention. The positive and negative electrode current collecting members 50 and 60 are respectively coupled to both ends of the electrode assembly 10. The positive and negative electrode current collecting members 50 and 60 are coupled to the positive and negative electrode terminals 21 and 22 that are exposed from the case 34. For example, terminal holes 51′ and 61′ are respectively formed in upper portions of the positive and negative electrode current collecting members 50 and 60, and the positive and negative electrode terminals 21 and 22 are partially inserted into the terminal holes 51′ and 61′ respectively. TIG-welding may be performed along a boundary between the positive and negative electrode current collecting members 50 and 60 and the positive and negative electrode terminals 21 and 22.

The positive and negative electrode current collecting members 50 and 60 electrically couple the electrode assembly 10 to the positive and negative electrode terminals 21 and 22, and form a path of charging/discharging current between the electrode assembly 10 and each of the positive and negative electrode terminals 21 and 22. Battery current generated from the electrode assembly 10 may be applied to the outside of the secondary battery 20 via the positive and negative electrode terminals 21 and 22. The positive and negative electrode current collecting members 50 and 60 may include the positive and negative electrode current collecting terminals 52 and 62, coupled to the electrode assembly 10, and positive and negative electrode connecting members 51 and 61 that extend from the positive and negative electrode current collecting terminals 52 and 62 and are respectively coupled to the positive and negative electrode terminals 21 and 22.

The retainer 80 is coupled to each end of the electrode assembly 10. In one embodiment, a pair of retainers 80 is provided, each of the pair corresponding to a positive electrode or a negative electrode of the electrode assembly 10.

The retainer 80 may be coupled to the electrode assembly 10 so as to surround each of the positive and negative electrode current collecting members 50 and 60 together with the end of the electrode assembly 10. Each of the positive and negative electrode current collecting members 50 and 60 and the electrode assembly 10 are coupled to each other by being inserted into the retainer 80. In this case, the accommodation portion 80′ of the retainer 80 for defining an accommodation space of the electrode assembly 10 may be formed to be sufficiently narrow so that the positive and negative electrode current collecting members 50 and 60 and the electrode assembly 10 are coupled to the retainer 80 by forced insertion or an interference fit. For example, the retainer 80 may be coupled to the end of the electrode assembly 10 such that the retainer 80 presses the end of the electrode assembly 10, so that the positive and negative non-coated portions 11c and 12c of the electrode assembly 10 are concentrated.

In one embodiment of the present invention, the retainer 80 is coupled to the electrode assembly 10 such that a width w of the accommodation portion 80′ is enlarged, so that the retainer 80 accommodates the positive and negative electrode current collecting members 50 and 60 and the electrode assembly 10. Furthermore, the retainer 80 provides a bias force to firmly fix the electrode assembly 10 to the positive and negative electrode current collecting members 50 and 60. In this case, the retainer 80 may be formed of an elastic material.

FIG. 6 is a view illustrating the retainer 80 according to an embodiment of the present invention.

Referring to FIG. 6, the retainer 80 may be formed as a clip type member having the accommodation portion 80′ so that the positive and negative electrode current collecting members 50 and 60 and the electrode assembly 10 are inserted into the retainer 80. In this case, coupling between each of the positive and negative electrode current collecting members 50 and 60 and the electrode assembly 10, which are inserted into the accommodation portion 80′, may be controlled by controlling the width w of the accommodation portion 80′. In one embodiment of the present invention, the accommodation portion 80′ of the retainer 80 may be formed to be offset from the center of the retainer 80 along a first direction Z1 that is substantially perpendicular to a main surface of the secondary battery 20. That is, a first rib width w1 from a side of the retainer 80 to the accommodation portion 80′ and a second rib width w2 from the other side of the retainer 80 to the accommodation portion 80′ may be designed to have different values (w1≠w2).

In this case, the main surface of the secondary battery 20 is a surface that occupies the largest area in a nearly rectangular shape forming an exterior of the secondary battery 20. For example, the first direction Z1 may be a direction in which the secondary batteries 20 are arranged in the battery module 100 (see FIG. 1). The accommodation portion 80′ accommodating the positive and negative electrode current collecting members 50 and 60 may be respectively formed to correspond to locations of the positive and negative electrode current collecting members 50 and 60, and may be formed to be offset from the center of the retainer 80 according to a detailed design of the secondary battery 20.

The accommodation portion 80′ of the retainer 80 may be formed to have a sufficient length t so as to cover the positive and negative non-coated portions 11c and 12c and parts of the active material layers 11b and 12b of the electrode assembly 10. Since a contact area between the retainer 80 and the electrode assembly 10 is enlarged, coupling strength therebetween increases, and thus the electrode assembly 10 may be further firmly fixed to the retainer 80 by the increased coupling. Furthermore, from a structural rigidity point of view, the electrode assembly 10 is supported by the active material layers 11b and 12b having higher resistance to transformation, instead of by the positive and negative non-coated portions 11c and 12c where active materials are not formed, and thus the electrode assembly 10 may be further firmly fixed to the retainer 80.

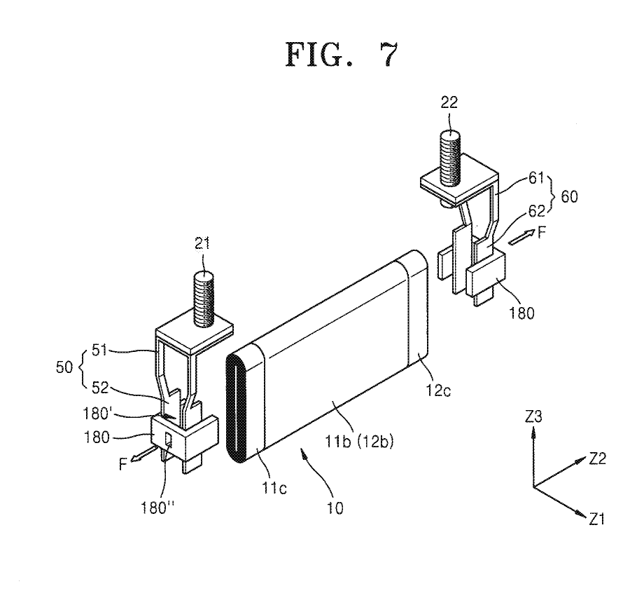

FIG. 7 is a perspective view illustrating an assembled state of a retainer 180 according to another embodiment of the present invention. The retainer 180 is coupled to an end of an electrode assembly 10. In FIG. 7, a gas discharging hole 180″ is formed in the retainer 180. In one embodiment of the present invention, the gas discharging hole 180″ may be formed to face an accommodation portion 180′ of the retainer 180, and the electrode assembly 10 inserted into the accommodation portion 180′ may be exposed to the outside through the gas discharging hole 180″. The gas discharging hole 180″ provides a discharging path F of gas generated in the electrode assembly 10, and thus a risk of explosion due to accumulation of gas pressure may be reduced.

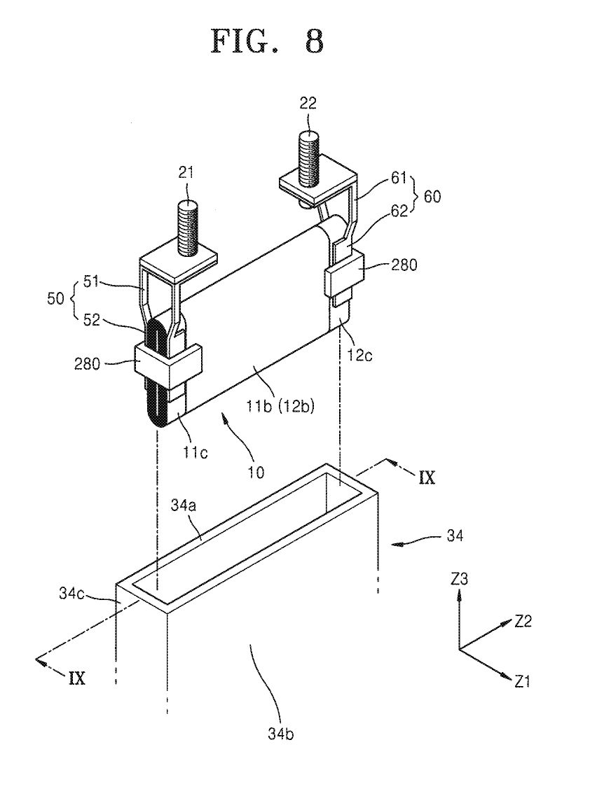

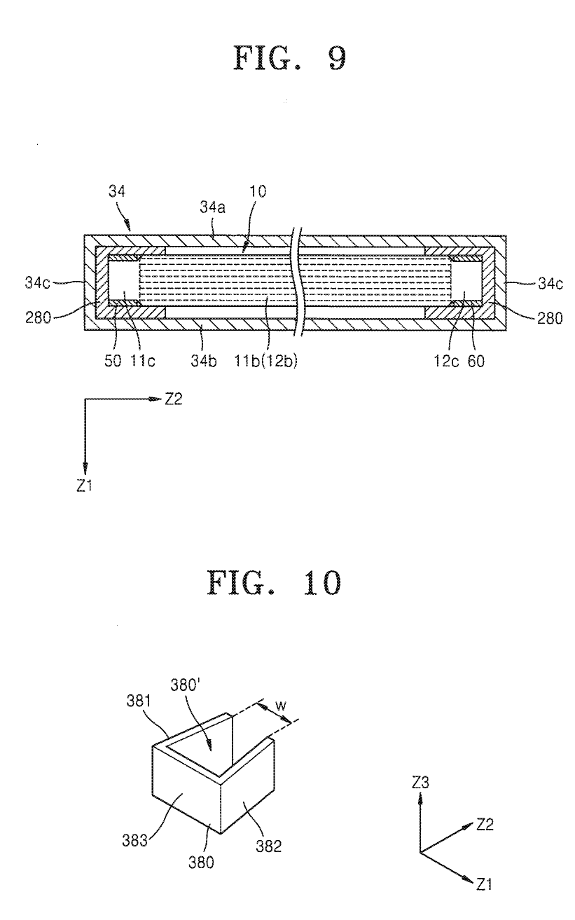

FIG. 8 is a perspective view illustrating an assembly state of a retainer 280 according to another embodiment of the present invention. FIG. 9 is a cross-sectional view taken along a line IX-IX of FIG. 8.

Referring to FIGS. 8 and 9, the retainer 280 may be coupled to an electrode assembly 10 to generally surround the electrode assembly 10. The retainer 280 may contact inner walls 34a, 34b and 34c of a case 34 and may be supported by the inner walls 34a, 34b and 34c of the case 34. For example, the retainer 280 may be tightly coupled to main surfaces 34a and 34b, facing each other in a first direction Z1, and both side surfaces 34c of the case 34. The location of the retainer 280 for fixing the electrode assembly 10 is restricted by the inner walls 34a, 34b and 34c of the case 34, and thus the electrode assembly 10 may be further firmly fixed.

The retainer 280 may be tightly coupled to at least one surface of the case 34. For example, the retainer 280 may be tightly coupled to the side surface 34c of the case 34 in order to restrict movement of the electrode assembly 10 in a second direction Z2. The movement of the electrode assembly 10 may be restricted by the retainer 280 supported by the both side surfaces 34c facing each other in the second direction Z2, and thus the location of the electrode assembly 10 may be further firmly fixed.

Referring now to FIG. 10, a retainer 380 includes a first rib 381, a second rib 382 and a third rib 383, with the first and second ribs extending from the third rib. As shown in the figure, an angle between the first rib 381 and the third rib 383 and an angle between the second rib 382 and the third rib is less than 90 degrees such that a distance between free ends of the first and second ribs is less than a length of the third rib. Accordingly, a distance W of the accommodation portion 380′ decreases in a direction away from the third rib 383.

The accommodation portion 380′ of the retainer is configured to receive at least one the positive and negative electrode current collecting member in addition to the electrode assembly. In this embodiment, a coupling strength between each of the positive and negative electrode current collecting member and the electrode assembly inserted into the accommodation portion 380′ may be controlled or influenced by controlling the width of the accommodation portion.

As shown in FIG. 10, since the distance or width W of the accommodation portion 380′ decreases in a direction away from the third rib 383, a coupling strength between the electrode current collecting member and the electrode assembly may be improved.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A secondary battery comprising:
an electrode assembly comprising a first electrode plate, a second electrode plate, and a separator located between the first and second electrode plates, wherein the first electrode plate and the second electrode plate each have a coated portion and a non-coated portion;
a case housing the electrode assembly;
a first current collector and a second current collector electrically coupled to the electrode assembly; and
a retainer coupled to the electrode assembly and to the first current collector to fix the first current collector to the electrode assembly.

2. The secondary battery of claim 1, wherein the retainer is a clip.

3. The secondary battery of claim 1, wherein the retainer comprises a backing and two ribs extending from the backing to define an accommodation portion configured to receive a portion of the electrode assembly.

4. The secondary battery of claim 3, wherein the two ribs have different thicknesses.

5. The secondary battery of claim 1, wherein the retainer comprises an electrically insulating material.

6. The secondary battery of claim 1, wherein the retainer comprises an elastic material.

7. The secondary battery of claim 1, wherein the retainer biases the first current collector toward the electrode assembly.

8. The secondary battery of claim 7, wherein the retainer biases the first current collector in a thickness direction of the electrode assembly.

9. The secondary battery of claim 1, wherein the retainer is coupled to the electrode assembly by an interference fit.

10. The secondary battery of claim 1, wherein the retainer has an opening 180″.

11. The secondary battery of claim 1, wherein the retainer interacts between the case and the electrode assembly.

12. The secondary battery of claim 1, wherein the retainer contacts the case.

13. The secondary battery of claim 12, wherein the retainer is fixed to the case.

14. The secondary battery of claim 1, further comprising a second retainer coupled to the electrode assembly and to the second current collector.

15. The secondary battery of claim 1, wherein the first current collector is electrically coupled to the first electrode non-coated portion and the second current collector is electrically coupled to the second electrode non-coated portion.

16. The secondary battery of claim 1, wherein the retainer is fixed to the first electrode non-coated portion.

17. The secondary battery of claim 16, wherein the retainer is also fixed to the first electrode coated portion.

18. A battery module comprising:
a plurality of secondary batteries, each of the secondary batteries comprising:
an electrode assembly comprising a first electrode plate, a second electrode plate, and a separator located between the first electrode plate and the second electrode plate, wherein the first electrode plate and the second electrode plate each have a coated portion and a non-coated portion;
a case housing the electrode assembly;
a first current collector and a second current collector electrically coupled to the electrode assembly; and
a retainer coupled to the electrode assembly and to the first current collector to fix the first current collector to the electrode assembly.
